(19) United States
(12) Patent Application Publication
(10) Pub. No.: US 2016/0180252 A1
(43) Pub. Date: Jun. 23, 2016

(54) EVALUATION SOLUTIONS OF OPTIMIZATION PROBLEMS

(71) Applicant: International Business Machines Corporation, Armonk, NY (US)

(72) Inventor: Takayuki YOSHIZUMI, Tokyo (JP)

(21) Appl. No.: 14/976,280

(22) Filed: Dec. 21, 2015

(30) Foreign Application Priority Data
Dec. 19, 2014 (JP) 2014-257292

(51) Int. Cl. G06N 99/00; G06N 5/02

(52) U.S. Cl. CPC G06N 99/005; G06N 5/02

(57) ABSTRACT

A generation device generating an evaluation function for calculating an evaluation value of an evaluation target, the generation device including an acquisition unit acquiring learning data including a qualitative evaluation of the evaluation target; a generation unit generating a constraint to be satisfied by a value of the evaluation function for the evaluation target, based on the learning data; and a setting unit setting weight for a plurality of attributes in the evaluation function so that the constraint is satisfied, and the like are provided.

### CROSS-REFERENCE TO RELATED APPLICATIONS

This application is based upon and claims priority from Japanese Patent Application Number 2014-257292, filed on Dec. 19, 2014, the entire disclosure of each application is incorporated by reference in its entirety.

### BACKGROUND

The present invention generally relates to evaluating solutions, and more specifically to evaluating solutions of optimization problems.

Methods for evaluating solutions or the like of optimization problems or the like by using evaluation functions have been known (Non-patent Literature 1-2 and Patent Literature 1-2). For example, an approach to adjusting the weight of an evaluation function so that a quantitative evaluation of a solution by a human expert (for example, evaluation of a solution on a 100-point scale) matches an output value of an evaluation function has been known.

However, in known methods, evaluation criteria by an evaluator may be inconsistent, and evaluation criteria, scoring scales, and the like may differ from evaluator to evaluator when evaluations are made by a plurality of evaluators. Furthermore, since evaluation functions weighted directly with attribute values of an evaluation target are used in the known methods, a change in the attribute value of the evaluation target cannot be properly reflected in the evaluation function.

Accordingly, an evaluation function for accurately reproducing an evaluation result of a solution by an evaluator cannot be generated in known methods.

### SUMMARY

According to a conventional method, an inconsistency in evaluation may occur due to variations in evaluation criteria by an evaluator, and a reference point, a scoring scale, and the like of evaluation may differ from evaluator to evaluator when evaluations are made by a plurality of evaluators. Furthermore, weighting of a raw value of an attribute value of an evaluation target is often performed directly, and an attribute value cannot thus be taken into an evaluation function in an appropriate format.

According to a first aspect of the present invention, there is provided a generation device generating an evaluation function for calculating an evaluation value of an evaluation target, a generation method performed by the generation device, and a program product for use in the generation device, the generation device, the generation device including an acquisition unit acquiring learning data including a qualitative evaluation of the evaluation target; a generation unit generating a constraint to be satisfied by a value of the evaluation function for the evaluation target, based on the learning data; and a setting unit setting weight for a plurality of attributes in the evaluation function so that the constraint is satisfied.

The summary of the invention described above does not list all the necessary features of the present invention. Furthermore, sub-combinations of the above features may also be included in the present invention.

### BRIEF DESCRIPTION OF THE DRAWINGS

The accompanying figures wherein reference numerals refer to identical or functionally similar elements throughout the separate views, and which together with the detailed description below are incorporated in and form part of the specification, serve to further illustrate various embodiments and to explain various principles and advantages all in accordance with the present invention, in which:

FIG. 1 is a block diagram of a generation device 10 according to an embodiment.

FIG. 2 illustrates an example of evaluation targets and qualitative evaluations.

FIG. 3 illustrates an example of qualitative evaluations according to an embodiment.

FIG. 4 illustrates a processing flow of the generation device 10 according to the embodiment.

FIG. 5 illustrates an example of a scatter diagram generated by a determination unit 170.

FIG. 6 illustrates an example of a scatter diagram based on additionally acquired qualitative evaluations.

FIG. 7 illustrates an example of a hardware configuration of a computer 1900.

### DETAILED DESCRIPTION

As required, detailed embodiments are disclosed herein; however, it is to be understood that the disclosed embodiments are merely examples and that the systems and methods described below can be embodied in various forms. Therefore, specific structural and functional details disclosed herein are not to be interpreted as limiting, but merely as a basis for the claims and as a representative basis for teaching one skilled in the art to variously employ the present subject matter in virtually any appropriately detailed structure and function. Further, the terms and phrases used herein are not intended to be limiting, but rather, to provide an understandable description of the concepts.

The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The present invention is described below through an embodiment of the invention. However, the following embodiment does not limit inventions according to claims. Not all of combinations of features described in the embodiment are always essential for the solution of the invention.

Hereinafter, the present invention will be described through embodiments. However, the embodiments described below are not intended to limit the invention according to the scope of the claims. Furthermore, all the combinations of the features described in the embodiments are not necessarily essential to the solution to the present invention.

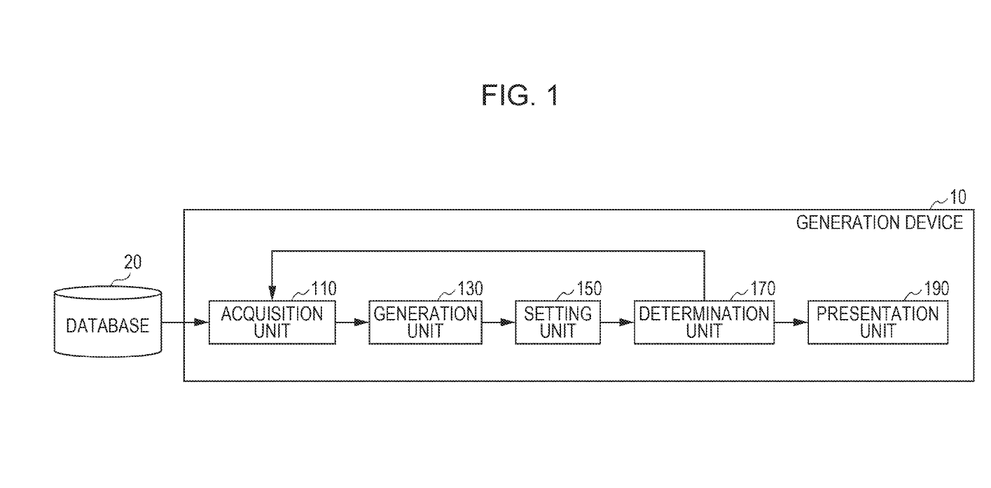

FIG. 1 is a block diagram of a generation device 10. The generation device 10 generates an evaluation function for calculating an evaluation value of an evaluation target. For example, the generation device 10 generates an evaluation function to which a solution of an optimization problem is input and from which an evaluation value indicating a qualitative evaluation of the solution is output. The generation device 10 includes an acquisition unit 110, a generation unit 130, a setting unit 150, a determination unit 170, and a presentation unit 190.

The acquisition unit 110 acquires learning data which includes an evaluation target and a qualitative evaluation of the evaluation target by an evaluator. For example, the acquisition unit 110 acquires from an external database 20 or the like learning data which includes an evaluation target including an attribute value for each attribute (for example, an attribute value of 0.76 for an attribute “filling ratio”) and a qualitative evaluation including a comparison result (for example, “an evaluation target i is slightly better than an evaluation target j) obtained by a qualitative comparison between two or more evaluation targets by an evaluator. The acquisition unit 110 supplies the acquired learning data to the generation unit 130.

The generation unit 130 generates constraints to be satisfied by a value of an evaluation function for an evaluation target, based on learning data. For example, the generation unit 130 generates, as constraints, an inequality which includes a difference in evaluation value of an evaluation function between two or more evaluation targets as comparison targets and an evaluation threshold as a criterion for a qualitative evaluation. Furthermore, for example, the generation unit 130 generates constraints based on an evaluation function which includes a term based on the weighted sum of a plurality of basis functions to which an attribute value is input for each attribute of an evaluation target.

The generation unit 130 generates an objective function whose output value is a target of optimization (for example, minimization) and which includes a plurality of variables. For example, the generation unit 130 generates an objective function including an error variable. The generation unit 130 may generate an objective function including the total number of basis functions included in an evaluation function. The details of constraints and an objective function generated by the generation unit 130 will be described later. The generation unit 130 supplies the generated constraints and objective function to the setting unit 150.

The setting unit 150 sets values of variables in constraints and values of variables in an objective function, for optimizing an output value of the objective function while satisfying the constraints. For example, the setting unit 150 sets the weights for one or a plurality of attributes in an evaluation function, the weight for each of a plurality of basis functions, and values of evaluation thresholds so that an output value of an objective function is minimized while constraints generated by the generation unit 130 being satisfied. The setting unit 150 supplies the set of values of each variable to the determination unit 170.

The determination unit 170 calculates a difference in evaluation value between two or more evaluation targets, by using an evaluation function based on the weight set by the setting unit 150. The determination unit 170 determines whether or not the calculated difference between the evaluation values falls within a reference range with respect to the evaluation threshold set by the setting unit 150. The determination unit 170 supplies a determination result to the presentation unit 190.

When the determination unit 170 determines that the difference between the evaluation values does not fall within the reference range, the presentation unit 190 presents to an evaluator a pair of evaluation targets for which a difference between the evaluation values close to the evaluation threshold may be obtained. For example, the presentation unit 190 presents to an evaluator two or more evaluation targets for which the difference in evaluation value between the two or more evaluation targets for the current evaluation function falls within the reference range.

When the determination result by the determination unit 170 is negative, an evaluation threshold, close to which there is no data, is obtained, and therefore the accuracy of the evaluation threshold may not be sufficient. Thus, it is desirable that data close to the evaluation threshold is added in order to increase the accuracy of the evaluation threshold. The presentation unit 190 presents to an evaluator an evaluation target for obtaining data close to the threshold. Accordingly, the presentation unit 190 is able to cause the acquisition unit 110 to acquire a qualitative evaluation by the evaluator for the presented evaluation target, and the generation device 10 is thus able to perform additional learning to increase the accuracy of the evaluation threshold.

As described above, the generation device 10 acquires learning data which includes a qualitative evaluation of a comparison result of evaluation targets by an evaluator to generate constraints and an objective function based on the qualitative evaluation. The qualitative evaluation of the comparison result of the evaluation targets is based on an ordinal scale indicating the order of evaluation targets and is not based on a ratio scale such as a scale and a reference point.

Therefore, the generation device 10 solves an objective function with constraints generated based on qualitative evaluations as an ordinal scale, and is therefore able to generate an evaluation function with less variations or the like which may be caused by an evaluation by an evaluator based on the ratio scale. Furthermore, the generation device 10 generates an evaluation function which includes a term based on the weighted sum of a plurality of basis functions to which an attribute value is input for each attribute of an evaluation target, and is therefore able to optimize the influence on an evaluation value exerted by an attribute value for each attribute.

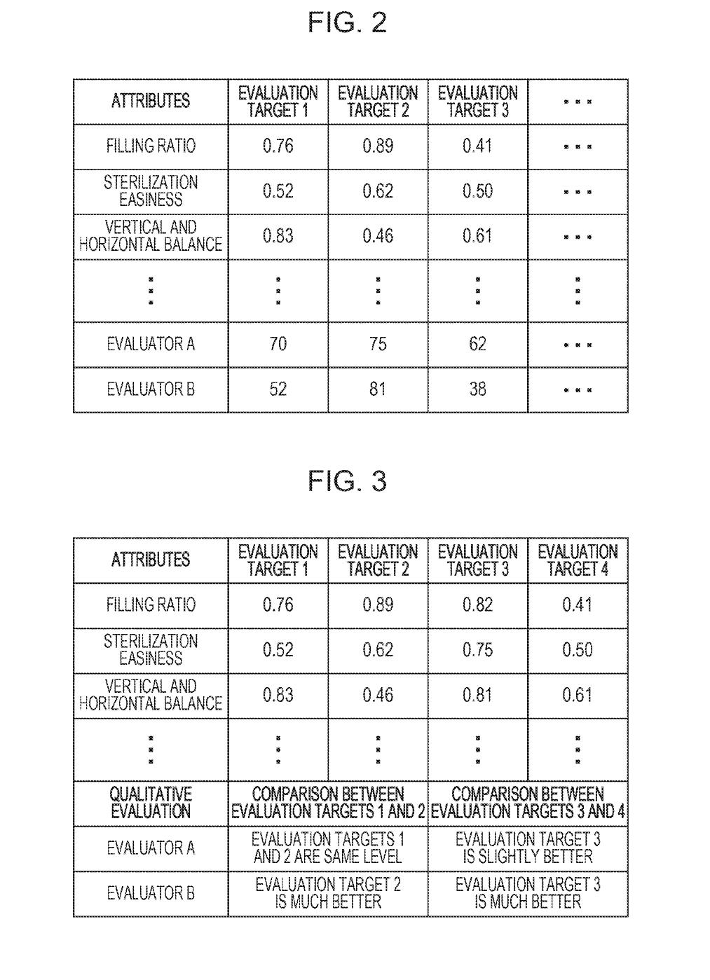

FIG. 2 illustrates an example of evaluation targets and quantitative evaluations of evaluation targets in conventional methods. An evaluation target 1, an evaluation target 2, an evaluation target 3, and so on illustrated in the table of FIG. 2 are different evaluation targets as targets for which evaluation values are output using an evaluation function. The evaluation targets 1 to 3 and so on may be solutions obtained by solving an optimization problem by a solver, solutions generated from an optimization problem by a human expert, simulation results obtained by inputting initial conditions, and the like.

Here, for example, the case where an evaluation target is a packing for medical equipment used in operations or the like will be explained. Packings as evaluation targets 1 to 3 are evaluated according to attributes such as “filling ratio (whether or not sufficient equipment are packed in a space)”, “sterilization easiness (whether or not packing is easy for sterilization)”, “vertical and horizontal balance (whether or not the vertical and horizontal balance of packing is good)”, and the like.

For example, for the evaluation target 1, an attribute “filling ratio” has an attribute value of 0.76, an attribute “sterilization easiness” has an attribute value of 0.52, and an attribute “vertical and horizontal balance” has an attribute value of 0.83. As a result, an evaluator A rates the evaluation target 1 at 70 out of 100, and an evaluator B rates the evaluation target 1 at 52 out of 100.

For example, for the evaluation target 2, the attribute “filling ratio” has an attribute value of 0.89, the attribute “sterilization easiness” has an attribute value of 0.62, and the attribute “vertical and horizontal balance” has an attribute value of 0.46. As a result, the evaluator A rates the evaluation target 2 at 75 out of 100, and the evaluator B rates the evaluation target 2 at 81 out of 100

For example, for the evaluation target 3, the attribute “filling ratio” has an attribute value of 0.41, the attribute “sterilization easiness” has an attribute value of 0.50, and the attribute “vertical and horizontal balance” has an attribute value of 0.61. As a result, the evaluator A rates the evaluation target 3 at 62 out of 100, and the evaluator B rates the evaluation target 3 at 38 out of 100.

The quantitative evaluations for each evaluation target by the evaluator A and the evaluator B have a common tendency. That is, each of the evaluator A and the evaluator B evaluates that the evaluation target 2 is the best, the evaluation target 1 is the second best, and the evaluation target 3 is the worst.

However, quantitative characteristics of evaluations by the evaluator A and the evaluator B greatly differ from each other. For example, the average and the variance of the evaluation results of the evaluation targets 1 to 3 by the evaluator A are 69 and 29, respectively, whereas the average and the variance of the evaluation results of the evaluation targets 1 to 3 by the evaluator B are 57 and 321, respectively. That is, the evaluator A has a reference point higher than the evaluator B, and the scale of evaluation by the evaluator A is smaller than the evaluator B (that is, the evaluator A tends to be lenient in evaluation and the distinction between superiority and inferiority tends to be small).

Furthermore, even when the same evaluator evaluates a plurality of evaluation targets, variations may occur in evaluations. For example, when a single evaluator evaluates a great number of evaluation targets, the reference point, scale, and the like of evaluation may vary between the beginning and the ending of the evaluation. Due to the difference/variation or the like of the reference and scale in the ration scale, it has been difficult to accurately learn an evaluation function for reproducing evaluations by a plurality of evaluators from quantitative evaluations.

FIG. 3 illustrates an example of a qualitative evaluation according to an embodiment. The acquisition unit 110 according to this embodiment acquires, for evaluation targets similar to those illustrated in FIG. 2, as learning data, a qualitative evaluation which includes qualitative comparison results of a plurality of evaluation targets. For example, the acquisition unit 110 acquires, instead of the quantitative evaluations illustrated in FIG. 2, a comparison result of the evaluation target 1 and the evaluation target 2 by the evaluator A (the evaluation target 1 and the evaluation target 2 are same level), a comparison result of the evaluation target 3 and the evaluation target 4 by the evaluator A (the evaluation target 3 is slightly better), a comparison result of the evaluation target 1 and the evaluation target 2 by the evaluator B (the evaluation target 2 is much better), and a comparison result of the evaluation target 3 and the evaluation target 4 by the evaluator B (the evaluation target 3 is much better).

As illustrated in FIG. 3, the evaluator A and the evaluator B evaluate evaluation targets according to different criteria. For example, the evaluator B tends to feel a greater distinction between superiority and inferiority of evaluation targets. However, the generation unit 130 according to this embodiment generates constraints which include such a difference between evaluators, and is therefore able to generate an evaluation function which is less affected by the difference between the evaluators.

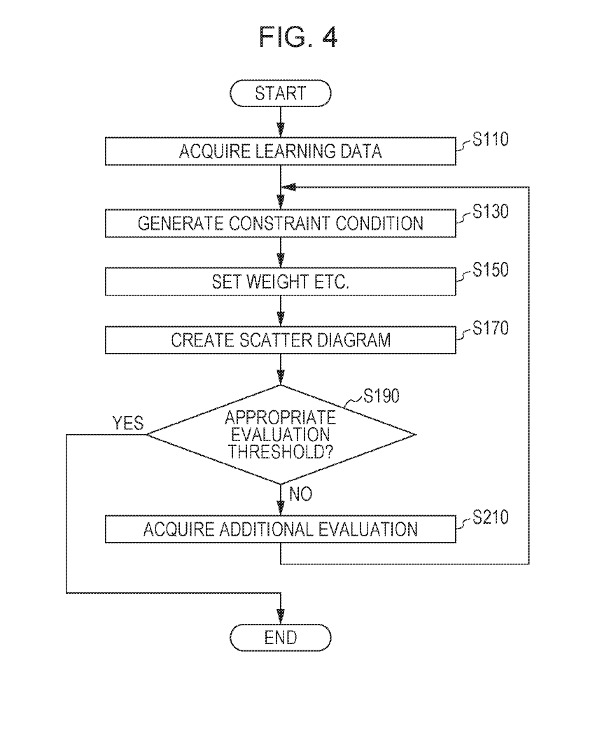

FIG. 4 illustrates a processing flow of the generation device 10 according to an embodiment. In this embodiment, the generation device 10 generates an evaluation function corresponding to learning data by performing processing of S110 to S210.

First, in S110, the acquisition unit 110 acquires learning data for generating an evaluation function. For example, the acquisition unit 110 acquires learning data which includes an evaluation target including attribute values for each attribute and qualitative evaluations of the evaluation target by evaluators. The acquisition unit 110 may acquire learning data from a storage device which is arranged inside the generation device 10, the external database 20 which is connected to the generation device 10, and/or a network.

The acquisition unit 110 may treat a solution obtained by solving an optimization problem, a solution obtained by simulation, a solution generated by a human expert, and the like as evaluation targets. For example, the acquisition unit 110 may treat an operation method (for example, a method for packing surgical tools), scheduling (for example, a manufacturing process for products or the like or a transportation diagram), behavior in a game/competition (for example, moves in Japanese chess), business strategies/tactics (for example, opening of a franchised store), and/or a creation (architectural design or art work) and the like as evaluation targets.

The acquisition unit 110 acquires attribute values of each attribute of each evaluation target i as an evaluation target. For example, the acquisition unit 110 acquires an attribute vector x⁽ⁱ⁾=(xᵢ₁, xᵢ₂, . . . , xᵢₖ), which is constituted of K attribute values of an evaluation target i. For example, the acquisition unit 110 acquires a integer values, binary values, or real number values representing the property/characteristic of an evaluation target as attribute values. The acquisition unit 110 may acquire two or more attribute values for one attribute. For example, the acquisition unit 110 may acquire an attribute vector which includes a plurality of attribute values for each attribute, and acquire a vector obtained by connecting the attribute vectors as an evaluation target.

The acquisition unit 110 acquires, as a qualitative evaluation of an evaluation target, qualitative evaluations which include comparison results of a qualitative comparison between two or more evaluation targets by evaluators. For example, the acquisition unit 110 may acquire a comparison result and a pair of evaluation targets as comparison targets included in learning data, and acquire, as a qualitative evaluation, a result obtained by categorizing the pair of evaluation targets by comparison result. For example, the acquisition unit 110 may acquire, as a qualitative evaluation, comparison results of all the combinations of pairs (N×(N−1)×½) generated from all of the N evaluation targets or a result obtained by categorizing comparison results of some combinations of pairs.

The acquisition unit 110 acquires, as a qualitative evaluation, a result of categorization by a difference in evaluation between a pair of evaluation targets, based on a Likert scale. For example, the acquisition unit 110 may acquire a set of pairs R=^{(u)} which includes pairs that are categorized as “an evaluation target i and an evaluation target j are similar”, a set of pairs R>^{(u)} which includes pairs that are categorized as “the evaluation target i is slightly better than the evaluation target j”, and a set of pairs R>>^{(u)} which includes pairs that are categorized as “the evaluation target i is much better than the evaluation target j”.

Furthermore, the acquisition unit 110 may acquire, as a qualitative evaluation, a result obtained by categorizing groups each including three or more evaluation targets by type of comparison result. For example, the acquisition unit 110 may acquire, as qualitative evaluations, a set or groups R_{best} which includes the evaluation target i that is categorized as “the evaluation target i is the best among a group A_{g} which is constituted of a plurality of evaluation targets including the evaluation target i” and the group A_{g} or a set of groups R_{worst} which includes the evaluation target i that is categorized as “the evaluation target i is the worst among the group A_{g} which is constituted of a plurality of evaluation targets including the evaluation target i” and the group A_{g}.

The acquisition unit 110 may acquire, as a qualitative evaluation, a comparison result obtained by qualitatively comparing an evaluation target with a predetermined evaluation criterion, instead of/in addition to a qualitative evaluation based on a comparison result of a plurality of evaluation targets. For example, the acquisition unit 110 may acquire, as a qualitative evaluation, a comparison result obtained by qualitatively comparing each evaluation target with a single evaluation criterion or any of a plurality of evaluation criteria. For example, the acquisition unit 110 may acquire, as a qualitative evaluation, a comparison result obtained by comparing each evaluation target with a predetermined evaluation target as a model of a bad evaluation result, a predetermined evaluation target as a model of a medium evaluation result, a predetermined evaluation target as a model of a good evaluation result, or the like (similar to/better than/worse than an evaluation target as a model).

The acquisition unit 110 may acquire a qualitative evaluation by a single evaluator u. Instead of this, the acquisition unit 110 may acquire learning data which includes qualitative evaluations by a plurality of evaluators u (uεU). The acquisition unit 110 supplies the acquired learning data to the generation unit 130.

Next, in S130, the generation unit 130 generates, based on the learning data, constraints to be satisfied by an evaluation function for an evaluation target and an objective function as a target of optimization.

For example, the generation unit 130 generates, as a constraint, an inequality which includes a difference in evaluation value of an evaluation function between two or more evaluation targets as comparison targets and an evaluation threshold as a criterion of a qualitative evaluation. For example, the generation unit 130 generates an inequality which indicates that for each item in the pair (the evaluation target i and the evaluation target j) in the pair set R=^{(u)} that is represented by “the evaluation target i and the evaluation target j are similar” in the learning data, the absolute value of the value obtained by adding an error variable σᵢⱼ corresponding to the pair of the evaluation target i and the evaluation target j to the difference between an evaluation value f_{w}(x⁽ⁱ⁾) of an evaluation function for the evaluation target i and an evaluation value f_{w}(x^{(j)}) of an evaluation function for the evaluation target j is less than or equal to a first evaluation threshold zᵤ₀. For example, the generation unit 130 generates an inequality represented by Formula 1.

−zᵤ₀≦f_{w}(x⁽ⁱ⁾)−f_{w}(x^{(j)})+σᵢⱼ≦zᵤ₀ for each(i,j)εR_{≈}^{(u)} for each uεU

Furthermore, for example, the generation unit 130 generates an inequality which indicates that for each item of the pair (the evaluation target i and the evaluation target j) of the set of pairs R>^{(u)} that is represented by “the evaluation target i is slightly better than the evaluation target j” in the learning data, the absolute value of the value obtained by adding the error variable σᵢⱼ corresponding to the pair of the evaluation target i and the evaluation target j to the difference between the evaluation value f_{w}(x⁽ⁱ⁾) of the evaluation function for the evaluation target i and the evaluation value f_{w}(x^{(j)}) of the evaluation function for the evaluation target j is equal to or more than the first evaluation threshold zᵤ₀ and less than or equal to a second evaluation threshold zᵤ₁. For example, the generation unit 130 generates an inequality represented by Formula 2.)

zᵤ₀≦f_{w}(x⁽ⁱ⁾)−f_{w}(x^{(j)}+σᵢⱼ≦zᵤ₁ for each (i,j)εR_{>}^{(u)} each for each uεU

Furthermore, for example, the generation unit 130 generates an inequality which indicates that for each item of the pair (the evaluation target i and the evaluation target j) of the set of pairs R>>^{(u)} that is represented by “the evaluation target i is much better than the evaluation target j” in the learning data, the absolute value of the value obtained by adding the error variable σᵢⱼ corresponding to the pair of the evaluation target i and the evaluation target j to the difference between the evaluation value f_{w}(x⁽ⁱ⁾) of the evaluation function for the evaluation target i and the evaluation value f_{w}(x^{(j)}) of the evaluation function for the evaluation target j is equal to or more than the second evaluation threshold zᵤ₁. For example, the generation unit 130 generates an inequality represented by Formula 3.

zᵤ₁≦f_{w}(x⁽ⁱ⁾)−f_{w}(x^{(j)})+σᵢⱼ for each (i,j)εR_{>>}^{(u)} for each uεU

Furthermore, for example, the generation unit 130 generates a constraint from each group of the set of groups R_{best} that is represented by “the evaluation target i is the best among the group Ag which is constituted of a plurality of evaluation targets including the evaluation target i” in the learning data. For example, the generation unit 130 generates an inequality which indicates that for each item of the plurality of pairs of the evaluation target i and the evaluation target j different from the evaluation target i that are generated from the group, the absolute value of the value obtained by adding the error variable σᵢⱼ corresponding to the pair of the evaluation target i and the evaluation target j to the difference between the evaluation value f_{w}(x⁽ⁱ⁾) of the evaluation function for the evaluation target i and the evaluation value f_{w}(x^{(j)}) of the evaluation function for the evaluation target j is equal to or more than 0. For example, the generation unit 130 generates an inequality represented by Formula 4.

f_{w}(x⁽ⁱ⁾)−f_{w}(x^{(j)})+σᵢⱼ≦0 for each {(i,j)|jεA_{g},(i,A_{g})εR_{best}}

Furthermore, for example, the generation unit 130 generates a constraint from each group of the set of groups R_{worst} that is represented by “the evaluation target i is the worst among the group Ag which is constituted of a plurality of evaluation targets including the evaluation target i” in the learning data. For example, the generation unit 130 generates an inequality which indicates that for each item of the plurality of pairs of the evaluation target i and the evaluation target j different from the evaluation target i that are generated from the group, the absolute value of the value obtained by adding the error variable σᵢⱼ corresponding to the pair of the evaluation target i and the evaluation target j to the difference between the evaluation value f_{w}(x⁽ⁱ⁾) of the evaluation function for the evaluation target i and the evaluation value f_{w}(x^{(j)}) of the evaluation function for the evaluation target j is less than or equal to 0. For example, the generation unit 130 generates an inequality represented by Formula 5.

f_{w}(x⁽ⁱ⁾)−f_{w}(x^{(j)})+σᵢⱼ≦0 for each {(i,j)|jεA_{g},(i,A_{g})εR_{worst}}

In the case where a qualitative evaluation for each evaluator u (uεU) is acquired as learning data, the generation unit 130 may generate, as a constraint, an inequality which includes an evaluation threshold for each evaluator u (uεU). For example, the generation unit 130 may generate the inequalities of Formulae 1 to 5 for each evaluator u. Instead of this, the generation unit 130 may generate the inequalities of Formulae 1 to 5 common to all evaluators.

The generation unit 130 generates a constraint for an evaluation function. For example, the generation unit 130 generates a constraint based on an evaluation function f_{w}(x) which includes a term wₖₗφₖₗ(xₖ) based on the weighted sum of Mₖ (an integer, where l and Mₖ satisfies 1≦l≦Mₖ) types basis functions φkₗ(xₖ) to which an attribute value xₖ is input for each attribute k (kεK) of an evaluation target.

The generation unit 130 may use various functions as the Mₖ types of basis functions φₖₗ (x). For example, the generation unit 130 may use ax+b, a(x−b)²+c, a(x−b)^{1/2}+c, a/(x−b)+c, a·exp(−b(x−c)²)+d, or a/(b+c·exp(d(x−e))), where a, b, c, d, and e may be predetermined constants, as a basis function φₖₗ(x). The generation unit 130 may use basis functions φₖₗ(x) of the same type with different constants (for example, x+5 and 2×−5, etc.).

For example, the generation unit 130 generates a constraint represented by Formula 6. The generation unit 130 thus defines an evaluation function.

$${f}_{w} ( x ) ≡ {\sum }_{1 \leq k \leq K} {\sum }_{1 \leq l \leq {M}_{k}} {w}_{kl} {φ}_{kl} ( {x}_{k} )$$

The generation unit 130 generates a constraint for the sum of all of the weights wₖₗ for all the types of basis functions 1εMₖ of all the attributes kεK. For example, the generation unit 130 generates a constraint in which the sum of all of the weights wₖₗ is 1. That is, the generation unit 130 generates a constraint represented by Formula 7.

[Math. 7]

$${\sum }_{1 \leq k \leq K} {\sum }_{1 \leq l \leq {M}_{k}} {w}_{kl} = 1 …$$

The generation unit 130 generates a constraint for the weight wₖₗ and a selection variable yₖₗ of a basis function. For example, the generation unit 130 generates a constraint in which the weight wₖₗ is equal to or more than 0 and less than or equal to yₖₗ. Furthermore, the generation unit 130 may also generate a constraint for defining the selection variable yₖₗ of a basis function as taking only one of 0 and 1.

Accordingly, when the selection variable yₖₗ of a basis function is 1, the weight of a corresponding basis function φₖₗ(x) in an evaluation function may be more than 0. Therefore, a basis function φₖₗ(x) may be allowed to adopt in an evaluation function. Meanwhile, when the selection variable yₖₗ of a basis function is 0, the weight of a corresponding basis function φₖₗ(x) in an evaluation function is fixed at 0. Therefore, the basis function φₖₗ(x) is not allowed to adopt in an evaluation function.

That is, the selection variable yₖₗ determines adoption or rejection of a basis function φₖₗ (x) in an evaluation function f_{w}(x). Thus, the generation unit 130 generates a constraint which includes a selection variable yₖₗ indicating whether or not each of the plurality of basis functions φₖₗ(x) is included. For example, the generation unit 130 generates constraints represented by Formula 8 and Formula 9.

0≦wₖₗ≦yₖₗ for each {(k,l)|1≦k≦K,1≦l≦Mₖ}

yₖₗε{0,1} for each {(k,l)1≦k≦K,1≦l≦Mₖ}

The generation unit 130 may generate constraints for restricting the number of basis functions φₖₗ(x) which may be adopted for each attribute k (kεK). For example, the generation unit 130 may generate a constraint in which the sum of the number of types of basis function φₖₗ (x) to be used is less than or equal to a predetermined number Bₖ in the term corresponding to the attribute k of the evaluation function. Accordingly, the generation unit 130 is able to prevent an evaluation function from excessively fitting learning data. For example, the generation unit 130 may generate a constraint represented by Formula 10, where Bₖ represents a predetermined integer which indicates the upper bound of the number of basis functions. Formula 10:

$${\sum }_{1 \leq l \leq {M}_{k}} {y}_{kl} \leq {B}_{k} for each 1 \leq k \leq K$$

The generation unit 130 may generate constraints in which the sum of weights of a basis function φₖₗ(x) which may be adopted for each attribute k (kεK) is equal to or more than a predetermined criterion Wₖ in an evaluation function. Accordingly, the generation unit 130 is able to avoid an evaluation function from failing to reflect some attributes of an evaluation target. For example, the generation unit 130 may generate constraints represented by Formula 11, where Wₖ represents a predetermined real number which indicates the lower

limit of the weighted sum. Formula 11

$${\sum }_{1 \leq l \leq {M}_{k}} {w}_{kl} \geq {W}_{k} for each 1 \leq k \leq K$$

The generation unit 130 may generate all the constraints for Formulae 1 to 11 or may omit some of these constraints. For example, the generation unit 130 may omit one of the constraints corresponding to Formulae 2 to 3 and the constraints corresponding to Formulae 4 to 5 and/or may omit constraints corresponding to at least some of Formulae 8 to 11.

The generation unit 130 generates an objective function along with constraints. For example, the generation unit 130 generates an objective function which includes the total sum of the absolute values of the error variables σᵢⱼ included in inequalities regarding evaluation thresholds. Furthermore, for example, the generation unit 130 may add the total sum of the selection variables yₖₗ to the objective function. In the case where the total sum of the selection variables yₖₗ is added to the objective function, the number of types of φₖₗ(x) which may be adopted for an evaluation function is reduced, and therefore the evaluation function may be prevented from excessively fitting learning data. For example, the generation unit 130 generates an objective variable according to Formula 12.

$${min}_{w , y} {\sum }_{( i , j ) ∈ R} \vert {σ}_{ij} \vert + {λ}_{y} {\sum }_{1 \leq k \leq K} {\sum }_{1 \leq l \leq {M}_{k}} {y}_{kl}$$

In Formula 12, λ_{y} represents a predetermined constant (for example, 1) and defines the balance in the evaluation function between the total sum of the error variables σᵢⱼ and the total sum of the selection functions yₖₗ. The generation unit 130 may fix variables such as the error variables σᵢⱼ and then optimize λ_{y} by a cross-validation.

The generation unit 130 supplies the generated constraints and objective function to the setting unit 150.

Next, in S150, the setting unit 150 optimizes the values of each variable including weight by using the sum of the number of basis functions included in an evaluation function and/or an objective function including error variables. For example, the setting unit 150 sets the weight Wₖₗ of each of a plurality of basis functions for one or a plurality of attributes in an evaluation function and the values of the evaluation thresholds Zᵤ₀ and Zᵤ₁ so that an output value of an objective function is optimized while the constraints generated in S130 being satisfied.

For example, the setting unit 150 sets the error variable σᵢⱼ for the evaluation targets i and j for each pair of evaluation targets and each group of evaluation targets, the weight Wₖₗ and the selection variable yₖₗ for each attribute k and each basis function 1, and the evaluation thresholds Zᵤ₀ and Zᵤ₁ for each evaluator so that the objective function represented by Formula 12 is minimized while the constraint represented by Formulae 1 to 11 being satisfied.

An optimization problem of an objective function with the constraints is a mixed integer programming (MIP). Therefore, the setting unit 150 may perform the processing of S150 by an existing solver (for example, IBM ILOG CPLEX). In the case where constraints using the selection variable yₖₗ are omitted, the setting unit 150 may perform simplified processing of S150 by solving a liner programming (LP). The setting unit 150 supplies the values of each of the determined variables to the determination unit 170.

Next, in S170, the determination unit 170 generates a scatter diagram from two or more evaluation targets of learning data, based on an evaluation function based on a variable such as determined weight. For example, the determination unit 170 inputs attribute values of a plurality of pairs of evaluation targets of learning data for which comparison results are obtained in S110 (that is, the set of pairs R=^{(u)}, the set of pairs R>^{(u)}, and the set of pairs R>>^{(u)}) to the evaluation function set in S150 to obtain evaluation values of evaluation targets for the pairs. Then, the determination unit 170 generates a scatter diagram in which the difference in evaluation value between items in a pair is expressed on the horizontal axis.

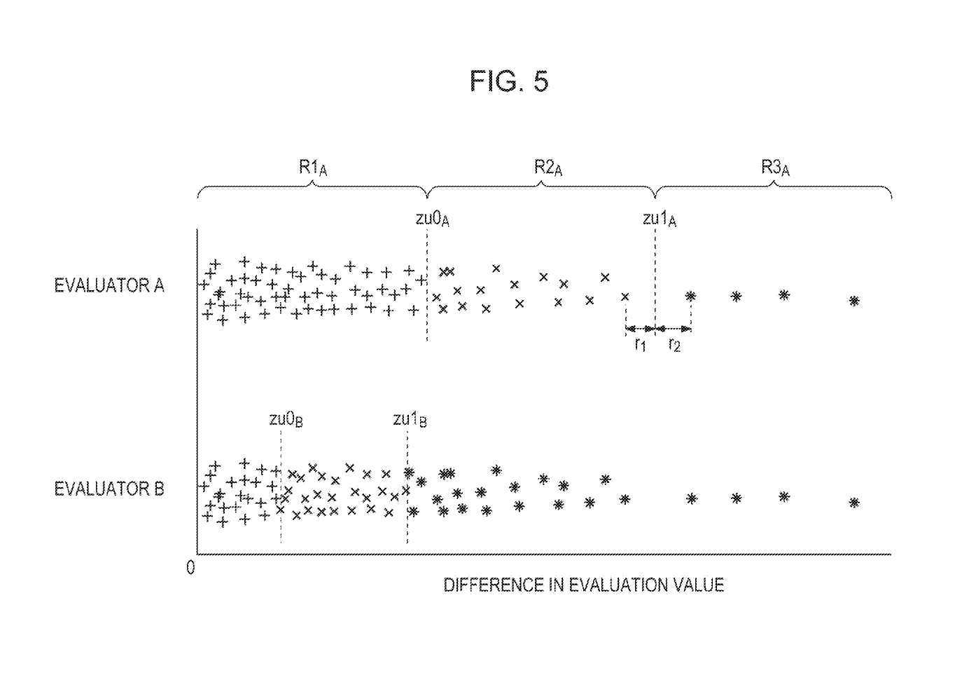

FIG. 5 illustrates an example of a scatter diagram generated by the determination unit 170. An example of a result of evaluations in which the two evaluators A and B evaluate a plurality of same pairs of evaluation targets is illustrated in FIG. 5. The determination unit 170 may generate a scatter diagram of evaluations in which a plurality of evaluators evaluate different pairs of evaluation targets. In FIG. 5, + corresponds to a pair of evaluation targets for which the evaluator A or the evaluator B determines that they are similar, X corresponds to a pair of evaluation targets for which the evaluator A or the evaluator B determines that one of them is slightly better than the other, and * corresponds to a pair of evaluation targets for which the evaluator A or the evaluator B determines one of them is much better than the other. In FIG. 5, R1_{A} represents a set of pairs constituted of pairs of evaluation targets for which the evaluator A determines that they are similar, R2_{A} represents a set of pairs constituted of pairs of evaluation targets for which the evaluator A determines that one of them is slightly better than the other, and R3_{A} represents a set of pairs constituted of pairs of evaluation targets for which the evaluator A determines that one of them is much better than the other.

In FIG. 5, Z_{u0A} represents a first evaluation threshold for division between R1_{A} and R2_{A}, Z_{u1A} represents a second evaluation threshold for division between R2_{A} and R3_{A}, Z_{u0B} represents a first evaluation threshold for the evaluator B, and Z_{u1B} represents a second evaluation threshold for the evaluator B. As illustrated in FIG. 5, the first evaluation threshold and the second evaluation threshold for the evaluator A are greater than the first evaluation threshold and the second evaluation threshold for the evaluator B. That is, in order that a difference is evaluated by the evaluator A, a large difference in evaluation is required compared to evaluation by the evaluator B.

Next, in S190, the determination unit 170 determines whether or not the values of the evaluation thresholds set in S150 are appropriate. For example, the determination unit 170 determines whether or not the value of the difference between evaluation values falls within a reference range with respect to an evaluation threshold in the scatter diagram generated in S170. For example, in FIG. 5, the second evaluation threshold Z_{u1A} for the evaluator A is away from evaluation values whose difference in evaluation value is the smallest by a distance r₁ and a distance r₂. It is determined whether a larger/smaller one of the distance r₁ and the distance r₂ or the sum of the distance r₁ and the distance r₂ is equal to or larger than a predetermined criterion.

The distance between an evaluation threshold and the difference between the evaluation values closest to the evaluation threshold is associated with the accuracy of the evaluation threshold. A large distance means that the setting unit 150 has set the evaluation threshold even though there is no data in the vicinity of the evaluation threshold, and therefore the reliability of the set evaluation threshold tends to be reduced. Thus, in the processing of step 190, the determination unit 170 determines whether or not the accuracy of an evaluation threshold is sufficient.

When it is determined that the difference falls within the reference range, the determination unit 170 ends the process. When it is determined that the difference does not fall within the reference range, the determination unit 170 supplies a determination result to the presentation unit 190, and proceeds the process to S210.

In S210, in response to the determination result that the difference between the evaluation values does not fall within the reference range with respect to the evaluation threshold, the acquisition unit 110 acquires an additional qualitative evaluation and adds the acquired additional qualitative evaluation to the learning data. For example, when the determination result indicates that the difference between the evaluation values does not fall within the reference range, the presentation unit 190 presents a pair of evaluation targets or a group of evaluation targets corresponding to the vicinity of the evaluation threshold to an evaluator. For example, the presentation unit 190 presents to an evaluator regarding an evaluation threshold two or more evaluation targets for which a difference in evaluation value between the two or more evaluation targets falls within the reference range with respect to the evaluation threshold in the current evaluation function.

After the presentation by the presentation unit 190, the acquisition unit 110 acquires an additional qualitative evaluation made by the evaluator for the presented two or more evaluation targets. For example, the presentation unit 190 presents to the evaluator A a pair of two evaluation targets or the like which are expected to provide a difference in the evaluation value close to the second evaluation threshold Z_{u1A} for the evaluator A, and acquires the differences n₁ and n₂ in evaluation value as qualitative evaluations.

The acquisition unit 110 adds the acquired additional qualitative evaluation to the learning data. The generation device 10 returns the process to S130. Consequently, the generation unit 130 generates a constraint again based on the learning data including the qualitative evaluation added thereto, and the setting unit 150 generates a new evaluation function.

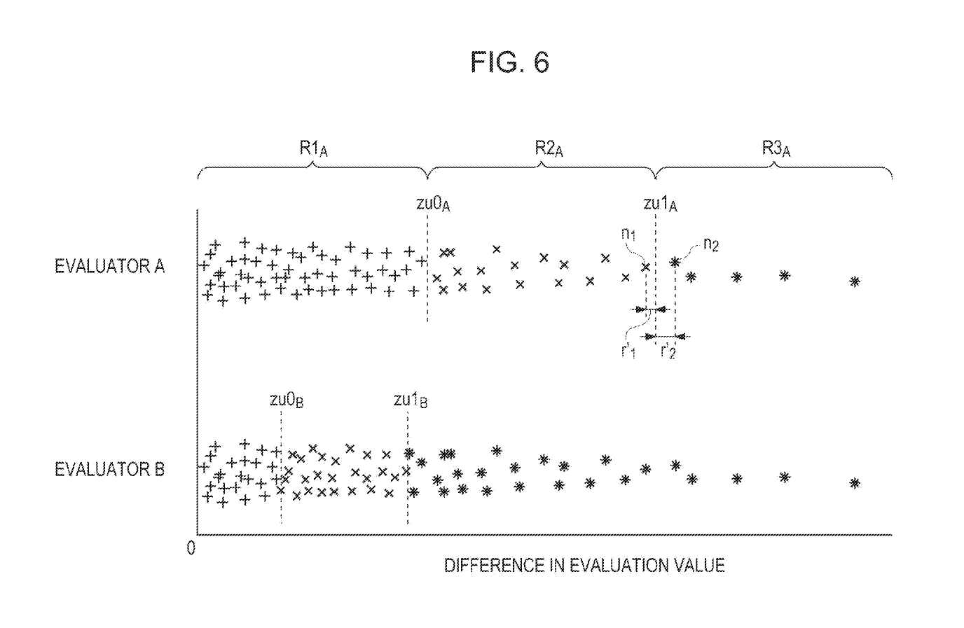

FIG. 6 illustrates an example of a scatter diagram obtained by evaluation functions generated based on additionally acquired qualitative evaluations. As illustrated in FIG. 6, differences n₁ and n₂ in evaluation value corresponding to the additional qualitative evaluations are illustrated in the vicinity of the second evaluation threshold Z_{u1A}. Here, the distance r′₁ and the distance r′₂ from the difference n₁ and the difference n₂ in evaluation value to the second evaluation threshold Z_{u1A} are shorter than the shortest distance r₁ and the shortest distance r₂ from the differences in evaluation value to the evaluation threshold before acquisition of the additional qualitative evaluations, respectively. Therefore, the generation device 10 is able to acquire a more accurate second evaluation threshold Z_{u1A} by the additional qualitative evaluations.

As described above, the generation device 10 solves an objective function with constraints generated based on a qualitative evaluation of a comparison result of evaluation targets by an evaluator. A qualitative evaluation of a comparison result which is based on an ordinal scale is excellent in consistency with less variations, compared to a quantitative evaluation based on a ratio scale. Therefore, the generation device 10 is able to generate an evaluation function that is less affected by an error caused by variations in evaluation criteria by an evaluator.

The generation device 10 generates constraints for which different evaluation thresholds are set for individual evaluators, while providing weighting common to evaluators on an evaluation function. Accordingly, an evaluation function common to a plurality of evaluators may be generated while a difference in comparison criteria among the plurality of evaluators being accepted.

Furthermore, the generation device 10 generates an evaluation function which includes a term based on the weighted sum of a plurality of basis functions to which an attribute value is input for each one or more of attributes of an evaluation target. That is, the generation device 10 generates an evaluation function for which an appropriate basis function is selected in association with the property of an attribute, and is therefore able to optimize the influence on an evaluation value exerted by an attribute value.

In the above example, the acquisition unit 110 acquires learning data which includes three steps of qualitative evaluation (same level, slightly better, and much better), and the generation unit 130 generates a constraint which includes the three steps of evaluation threshold. However, the acquisition unit 110 may acquire learning data which includes one or two steps or four or more steps of qualitative evaluation, and the generation unit 130 may generate a constraint which includes an inequality of evaluation thresholds corresponding to the steps of qualitative evaluation.

Furthermore, the acquisition unit 110 may acquire learning data which includes a qualitative evaluation obtained by comparing a difference in qualitative evaluation between two evaluation targets with a difference in qualitative evaluation between another two evaluation targets, in addition to/instead of learning data which includes a qualitative evaluation (same level, one is slightly better, and one is much better) obtained by comparison between two evaluation targets. For example, the acquisition unit 110 may acquire learning data which includes a qualitative evaluation such as “the difference between the evaluation target i₁ and the evaluation target i₂ is similar to/slightly larger than/much larger than the difference between the evaluation target i₃ and the evaluation target i₄”. In this case, the generation unit 130 generates a corresponding constraint (for example, −zᵤ₀≦|f_{w}(x⁽ⁱ¹⁾)−f_{w}(x⁽ⁱ²⁾)|−|f_{w}(x⁽ⁱ³⁾)≦f_{w}(x⁽ⁱ⁴⁾)|≦zᵤ₀ etc.).

In the above explanation for the embodiment, an example in which the generation device 10 acquires a qualitative evaluation of a plurality of evaluation targets to generate a constraint is described. In addition to/instead of this, the generation device 10 may acquire a qualitative evaluation of a difference in property among a plurality of evaluation targets to generate a constraint. For example, the generation unit 130 acquires a qualitative evaluation for a difference in property between a pair of evaluation targets by an evaluator (for example, “the evaluation target i and the evaluation target j are totally different in their properties”, “the evaluation target i and the evaluation target j are similar in their properties”, etc.) to generate an attribute vector from the attribute value of each of the evaluation targets. The generation unit 130 may generate a constraint which includes an inequality based on a Euclidean distance between attribute vectors of evaluation targets in the pair and the acquired qualitative evaluation.

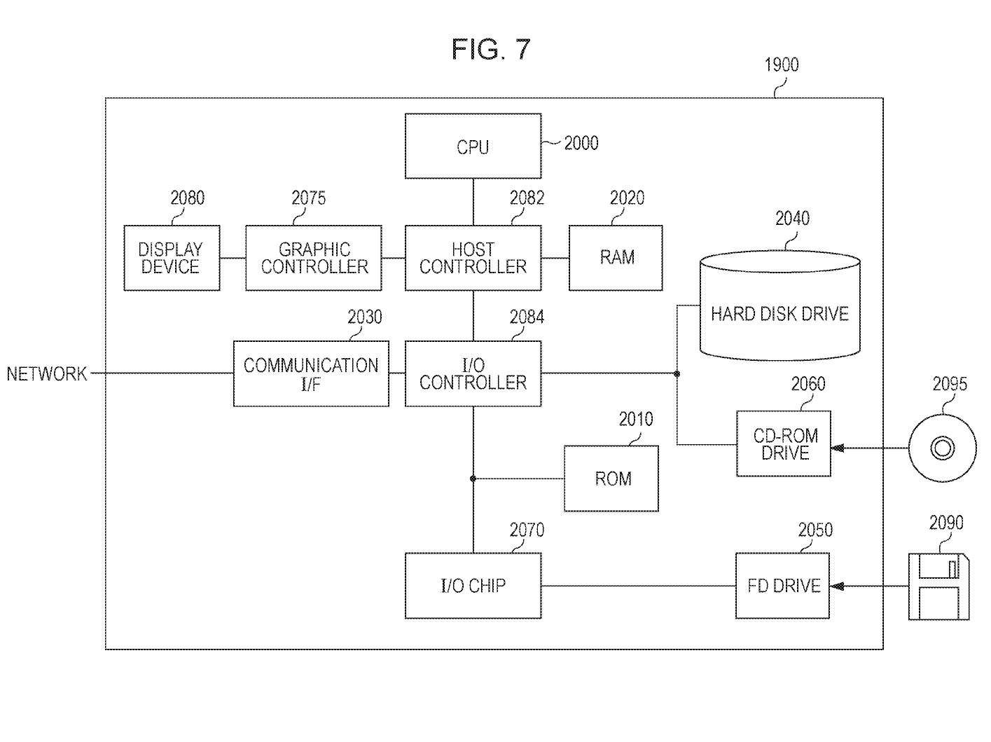

FIG. 7 illustrates an example of a hardware configuration of a computer 1900 functioning as the generation device 10. The computer 1900 according to this embodiment includes a CPU peripheral unit including a CPU 2000, a RAM 2020, a graphic controller 2075, and a display device 2080 which are connected to one another through a host controller 2082; an input/output unit including a communication interface 2030, a hard disk drive 2040, and a CD-ROM drive 2060 which are connected to the host controller 2082 through an input/output controller 2084; and a legacy input/output unit including a ROM 2010, a flexible disk drive 2050, and an input/output chip 2070 which are connected to the input/output controller 2804.

The host controller 2082 connects the RAM 2020 with the CPU 2000 which accesses the RAM 2020 at a high transfer rate and the graphic controller 2075. The CPU 2000 operates based on a program stored in the ROM 2010 and the RAM 2020, and controls individual units. The graphic controller 2075 acquires image data generated by the CPU 2000 or the like on a frame buffer provided inside the RAM 2020, and displays the image data on the display device 2080. Instead of this configuration, the graphic controller 2075 may include a frame buffer which stores image data generated by the CPU 2000 or the like.

The input/output controller 2084 connects the host controller 2082 with the communication interface 2030, which is a relatively high-speed input/output device, the hard disk drive 2040, and the CD-ROM drive 2060. The communication interface 2030 communicates with a different device via a network in a wired or wireless manner. Furthermore, the communication interface 2030 functions as hardware which performs communication. The hard disk drive 2040 stores a program and data to be used by the CPU 2000 in the computer 1900. The CD-ROM drive 2060 reads a program or data from a CD-ROM 2095, and supplies the read program or data to the hard disk drive 2040 via the RAM 2020.

To the input/output controller 2084, the ROM 2010, the flexible disk drive 2050, and a relatively low-speed input/output device such as and the input/output chip 2070, are connected. The ROM 2010 stores a boot program to be executed when the computer 1900 is activated and/or a program which depends on hardware of the computer 1900, and the like. The flexible disk drive 2050 reads a program or data from a flexible disk 2090, and supplies the read program or data to the hard disk drive 2040 via the RAM 2020. The input/output chip 2070 connects the flexible disk drive 2050 to the input/output controller 2084, and connects various input/output devices to the input/output controller 2084 via, for example, a parallel port, a serial port, a keyboard port, a mouse port, and the like.

A program supplied to the hard disk drive 2040 via the RAM 2020 is stored in a recording medium, such as the flexible disk 2090, the CD-ROM 2095, or an IC card, and supplied by a user. The program is read from the recording medium, installed into the hard disk drive 2040 in the computer 1900 via the RAM 2020, and executed by the CPU 2000.

The program which is installed into the computer 1900 and which causes the computer 1900 to function as the generation device 10 includes an acquisition module, a generation module, a setting module, a determination module, and a presentation module. The program or the module may encourage the CPU 2000 or the like to cause the computer 1900 to function as the acquisition unit 110, the generation unit 130, the setting unit 150, the determination unit 170, and the presentation unit 190.

When the information processing described in the above program is read into the computer 1900, the information processing functions as the acquisition unit 110, the generation unit 130, the setting unit 150, the determination unit 170, and the presentation unit 190, which are specific means in which software and the above-described various hardware resources cooperate. By achieving operation and processing of information corresponding to an intended purpose of the computer 1900 according to this embodiment with the above specific means, a particular generation device 10 suitable for the intended purpose can be constructed.

For example, in the case where communication is performed between the computer 1900 and an external device or the like, the CPU 2000 executes a communication program loaded onto the RAM 2020, and issues an instruction for communication processing to the communication interface 2030, based on the processing details described in the communication program. The communication interface 2030 reads transmission data stored in a transmission buffer region or the like provided on a storage device, such as the RAM 2020, the hard disk drive 2040, the flexible disk 2090, or the CD-ROM 2095, and transmits the read transmission data to a network or writes reception data received via the network onto a reception buffer region or the like provided on the storage device, under the control of the CPU 2000. As described above, the communication interface 2030 may transfer transmission and reception data to and from the storage device using a DMA (direct memory access) method. Instead of this configuration, the communication interface 2030 may transfer transmission and reception data by causing the CPU 2000 to read data from a storage device or the communication interface 2030 as a transfer source and writing the data to the communication interface 2030 or the storage device as a transfer destination.

Furthermore, the CPU 2000 causes all or necessary parts of a file, a database, or the like stored in an external storage device, such as the hard disk drive 2040, the CD-ROM drive 2060 (the CD-ROM 2095), or the flexible disk drive 2050 (the flexible disk 2090), to be read onto the RAM 2020 via DMA transfer or the like, and performs various types of processing for the data on the RAM 2020. Then, the CPU 2000 writes the processed data back to the external storage device via DMA transfer or the like. In such processing, the RAM 2020 may be regarded as temporarily retaining the contents of the external storage device. Therefore, in this embodiment, the RAM 2020, the external storage device, and the like are collectively referred to as a memory, a storage unit, a storage device, or the like.

For example, a storage unit of the generation device 10 may appropriately store data received from/to be supplied to the acquisition unit 110, the generation unit 130, the setting unit 150, the determination unit 170, and the presentation unit 190. For example, the storage unit may receive learning data supplied from the acquisition unit 110 to the generation unit 130 and store the received learning data. Furthermore, the storage unit may store a constraint and the like generated by the generation unit 130.

Various types of information of various programs, data, tables, databases, and the like in this embodiment are stored on such a storage device and serve as targets of information processing. The CPU 2000 may hold part of the RAM 2020 in a cache memory, and reading and writing may be performed on the cache memory. Also in such a form, the cache memory implements part of the function of the RAM 2020. Therefore, in this embodiment, except for the case where a distinction is made, the cache memory is also included in the RAM 2020, the memory, and/or the storage device.

Furthermore, the CPU 2000 performs various types of processing including various arithmetic operations, processing of information, condition determination, retrieval and replacement of information, and the like, which are directed by an instruction sequence of a program and described in this embodiment, for data read from the RAM 2020, and writes the processed data back to the RAM 2020. For example, in a condition determination, the CPU 2000 determines whether or not various variables illustrated in this embodiment satisfy the condition that the variables be greater than, smaller than, equal to or greater than, smaller than or equal to, or equal to another variable or constant, or the like. When the condition is met (or is not met), a branch to a different instruction sequence is provided or a subroutine is called.

Furthermore, the CPU 2000 is able to retrieve information stored in a file, a database, or the like in the storage device. For example, in the case where a plurality of entries in which attribute values of second attributes are associated with corresponding attribute values of first attributes are stored in the storage device, the CPU 2000 retrieves an entry whose attribute value of the first attribute matches a specified condition from among the plurality of entries stored in the storage device, and reads the attribute value of the second attribute stored in the corresponding entry. Thus, the attribute value of the second attribute corresponding to the first attribute that satisfies the specific condition can be obtained.

Furthermore, in the case where a plurality of elements are listed in an explanation for an embodiment, elements other than the listed elements may be used. For example, in the case where a description “X executes Y by using A, B, and C” is provided, X may execute Y by using D as well as A, B, and C.

While the embodiments of the present invention have been described above, the technical scope of the present invention is not limited to the scope of the foregoing embodiments. It is obvious to those skilled in the art that various changes or improvements can be made to the foregoing embodiments. It is also apparent from the scope of claims that the embodiments to which such changes or improvements are made can also be included in the technical scope of the present invention.

It should be noted that processes, such as operations, procedures, steps, and stages, performed by a device, a system, a program, and a method illustrated in the scope of claims, description, and diagrams can be performed in any order as long as the order is not particularly indicated by “prior to,” “before,” or the like and as long as an output from a previous process is not used in a later process. Even if an operation flow in the scope of claims, description, and diagrams is described using a phrase, such as “first” or “next”, it does not necessarily mean that the process must be performed in this order.

### NON-LIMITING EXAMPLES

The description of the present application has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A device for generating an evaluation function for calculating an evaluation value of an evaluation target, the device comprising:
an acquisition unit acquiring learning data including a qualitative evaluation of the evaluation target;
a generation unit generating a constraint to be satisfied by a value of the evaluation function for the evaluation target, based on the learning data; and
a setting unit setting weight for a plurality of attributes in the evaluation function so that the constraint is satisfied.

2. The device according to claim 1, wherein the acquisition unit acquires the learning data, which includes, as the qualitative evaluation, a comparison result obtained by qualitatively comparing two or more evaluation targets.

3. The device according to claim 1, wherein the acquisition unit acquires the learning data, which includes, as the qualitative evaluation, a comparison result obtained by qualitatively comparing the evaluation target with a predetermined evaluation criterion.

4. The device according to claim 1,
wherein the generation unit generates the constraints based on the evaluation function, which includes a term based on a weighted sum of a plurality of basis functions to which an attribute value is input for each attribute of the evaluation target, and
wherein the setting unit sets the weight of each of the basis functions so that the constraints are satisfied.

5. The device according to claim 4,
wherein the generation unit generates the constraint, which includes a variable indicating whether or not each of the plurality of basis functions is included, and
wherein the setting unit optimizes the weights by using an objective function including a total a number of basis functions included in the evaluation function.

6. The device according to claim 5,
wherein the generation unit generates the objective function, which includes error variables, and
wherein the setting unit optimizes the weights by using the objective function including the error variables.

7. The device according to claim 2,
wherein the generation unit generates the constraints, an inequality including a difference in evaluation value of the evaluation function between the two or more evaluation targets as comparison targets and an evaluation threshold as a criterion of the qualitative evaluation, and
wherein the setting unit sets a value of the evaluation threshold so that the constraints are satisfied.

8. The device according to claim 7,
wherein the acquisition unit acquires the learning data, which includes the qualitative evaluations made by a plurality of evaluators, and
wherein the generation unit generates, as the constraints, an inequality including the evaluation threshold for each evaluator.

9. The device according to claim 8, further comprising:
a determination unit determining whether or not the difference in evaluation value between the two or more evaluation targets according to the evaluation function based on the weight set by the setting unit falls within a predetermined reference range with respect to the evaluation threshold,
wherein in accordance with a determination result that the difference in the evaluation value does not fall within the reference range with respect to the evaluation threshold, the acquisition unit acquires an additional qualitative evaluation and adds the acquired additional qualitative evaluation to the learning data.

10. The device according to claim 9, further comprising:
a presentation unit presenting to the evaluator the two or more evaluation targets for which a difference in evaluation value between the two or more evaluation targets falls within a reference range,
wherein the acquisition unit acquires an qualitative evaluation made by an evaluator for the presented two or more evaluation targets and adds the acquired qualitative evaluation to the learning data.

11. A computer-implemented method for generating an evaluation function for calculating an evaluation value of an evaluation target, the method comprising:
acquiring learning data including a qualitative evaluation of the evaluation target;
generating a constraint to be satisfied by a value of the evaluation function for the evaluation target, based on the learning data; and
setting weight for a plurality of attributes in the evaluation function so that the constraint is satisfied.

12. The computer-implemented method according to claim 11, wherein the acquiring the learning data, which includes, as the qualitative evaluation, a comparison result obtained by qualitatively comparing two or more evaluation targets.

13. The computer-implemented method according to claim 11, wherein the acquiring the learning data, which includes, as the qualitative evaluation, a comparison result obtained by qualitatively comparing the evaluation target with a predetermined evaluation criterion.

14. The computer-implemented method according to claim 11,
wherein the generating the constraints based on the evaluation function, which includes a term based on a weighted sum of a plurality of basis functions to which an attribute value is input for each attribute of the evaluation target, and
wherein the setting unit sets the weight of each of the basis functions so that the constraints are satisfied.

15. The computer-implemented method according to claim 14,
wherein the generating the constraint, which includes a variable indicating whether or not each of the plurality of basis functions is included, and
wherein the setting unit optimizes the weights by using an objective function including a total a number of basis functions included in the evaluation function.

16. The computer-implemented method according to claim 15,
wherein the generating the objective function, which includes error variables, and
wherein the setting unit optimizes the weights by using the objective function including the error variables.

17. The computer-implemented method according to claim 12,
wherein the generating the constraints, an inequality including a difference in evaluation value of the evaluation function between the two or more evaluation targets as comparison targets and an evaluation threshold as a criterion of the qualitative evaluation, and
wherein the setting unit sets a value of the evaluation threshold so that the constraints are satisfied.

18. The computer-implemented method according to claim 17,
wherein the generating the constraint, which includes a variable indicating whether or not each of a plurality of basis functions is included, and
wherein the setting unit optimizes the weights by using an objective function including a total a number of basis functions included in the evaluation function.

19. A non-transitory computer program product for generating an evaluation function for calculating an evaluation value of an evaluation target comprising a computer readable storage medium having computer readable program code embodied therewith, the computer readable program code configured to perform:
acquiring learning data including a qualitative evaluation of the evaluation target;
generating a constraint to be satisfied by a value of the evaluation function for the evaluation target, based on the learning data; and
setting weight for a plurality of attributes in the evaluation function so that the constraint is satisfied.

20. The non-transitory computer program product according to claim 19, wherein the acquiring the learning data, which includes, as the qualitative evaluation, a comparison result obtained by qualitatively comparing two or more evaluation targets.
